(19) United States
(12) Patent Application Publication
(10) Pub. No.: US 2024/0388069 A1
(43) Pub. Date: Nov. 21, 2024

(54) APPARATUS AND METHOD FOR REMOVING AN INSULATING LAYER ON A LENGTH SECTION OF WIRE

(71) Applicant: GROB-WERKE GmbH & Co. KG, Mindelheim (DE)

(72) Inventors: Markus LUTZENBERGER, Mindelheim (DE); Clemens DREHER, Mindelheim (DE)

(21) Appl. No.: 18/664,685

(22) Filed: May 15, 2024

(30) Foreign Application Priority Data
May 17, 2023 (EP) 23173930.1

(51) Int. Cl. H02G 1/12

(52) U.S. Cl. CPC H02G 1/1265; H02G 1/127

(57) ABSTRACT

An apparatus for removing an insulating layer on a length portion of wire for forming a coil winding of an electrical machine, the apparatus comprising a wire guide for guiding through the wire in a wire moving direction, a slider arrangement having a plurality of sliders arranged around the wire and configured to displaced radially back and forth relative to the wire, wherein a cutting slider with a cutting edge for scraping the insulation and a counter bearing slider for counter-holding the wire during scraping are provided in such a way that the cutting slider and the counter bearing slider are opposite one another and can be moved towards and away from one another; and a cam disk with a recess or opening through which the wire is guided by wire guide. The cam disk being rotatable by a cam disk drive. Also a method and a computer program.

### CROSS-REFERENCES TO RELATED APPLICATIONS

This application claims the benefit of European Patent Application Number 23173930.1 filed on May 17, 2023, the entire disclosure of which is incorporated herein by way of reference.

### FIELD OF THE INVENTION

The invention relates to an apparatus for removing an insulating layer on a length section of wire for forming a coil winding of an electrical machine. The invention also relates to a method for removing an insulating layer on a length section of wire for forming a coil winding of an electrical machine.

### BACKGROUND OF THE INVENTION

For the technological background, reference is made to the following literature:
[1] EP 2 684 283 B1
[2] EP 1 554 794 B1
[3] EP 1 041 696 B1
[4] WO 2019/161 832 A1
[5] WO 2019/101 272 A1
[6] WO 2019/020148 A1
[7] WO 2019/166061 A1
[8] DE 10 2018 106 977 A1
[9] U.S. Pat. No. 11,018,482 B1
[10] EP 3 758 167 A1

Electrical machines are understood to mean especially machines for converting electrical energy into kinetic energy and machines for converting kinetic energy into electrical energy, such as electric motors and generators in particular. To manufacture machine elements of such electrical machines, for example stators or rotors, it is often necessary to shape, interconnect, cut or otherwise process electrically conductive wires. In particular, the wire can have a rectangular cross-section, be in the form of flat, square or profiled wire or for instance be in the form of flat strip steel or similar. The machine elements are usually manufactured in a production plant in which wire made of electrically conductive material is further processed. In this way, a continuous supply of material can be achieved in the manufacturing process when producing a machine element of an electrical machine, which leads to a high level of productivity.

In the manufacture of electric motors for motor vehicles, industrial series production processes with a high number of cycles are mostly used, which enable particularly economical production of high-performing components for electric motors.

Examples of production methods in which the apparatus and the method according to embodiments of the invention can be used are the hairpin method as well as the wave winding method. In the hairpin method, which is particularly preferred, coil windings, specifically those of the stator, are formed from different pieces of wire, the ends of which are joined together. Documents [1] to [4] for example describe devices and methods for performing different steps of the hairpin method, such as in particular the shaping of hairpins and connecting wire ends of hairpins to form stator windings of electrical machines, in which method the wire ends are welded together. In the wave winding method, examples of which are known from documents [4] to [7], the ends of the wave windings in particular are connected to each other or to an interconnection element for connecting the coil winding, especially by welding.

The starting material for manufacturing the different coil windings is usually a copper wire that is provided with an insulating layer. The insulating layer is predominantly made of plastic. As a rule, this is a rectangular wire (e.g. made of copper or another metal) with rounded edges. Welding the individual coil winding parts such as hairpins or wave winding wires to form a continuous winding constitutes an essential manufacturing step. The prerequisite for a flawless welded joint is that the two ends to be joined have no insulation layer over a defined length. The insulating layer, which is an insulating layer of varnish for example, is mainly removed by scraping or by using a plane. This can be done both in the longitudinal direction of the wire and transversely to the wire. Examples of known apparatus and methods for removing the insulation are disclosed in document [8].

Preferred embodiments of the invention are in the field of electric motor production using the hairpin method and relate to the removal of an insulating layer from a wire, usually copper wire. As already explained above, in the hairpin method, the wire is first bent into hairpins (i.e. a piece of wire in a configuration with a first and a second leg, where the wire runs essentially in a straight line, and with a generally roof-shaped three-dimensionally shaped connecting section between the legs, which in use forms a winding head) and the individual hairpins are later welded together, for which purpose the insulating layer at the welding point must first be removed. Various methods are already known for removing the insulating layer, for example by laser ablation, milling or scraping.

Stripping by milling produces a lot of small chips that are difficult to remove from the hairpin wire. Poor quality and contamination of the milled surfaces could result in defects in the weld seam formation. Preferred embodiments of the invention should therefore enable stripping by means of scraping in order to improve the quality and cleanliness of the stripped areas.

A method for scraping the insulating layer is disclosed in [9], wherein the insulating layer is removed by a pair of peeling blades which are fed orthogonally to the wire direction. The wire is held by opposing grippers, the movement of the blades relative to the wire also causing the grippers to advance.

[10] describes an apparatus for scraping insulating material, in which apparatus four blades are each mounted on a holder, with two blades working together in each case. By controlling the holders, all four sides of the wire are clamped by the blades. The platform with the copper wire is then moved, causing the coating to be scraped off the four blades.

### SUMMARY OF THE INVENTION

The invention is based on the problem of enabling high-quality stripping at high speed.

To solve this problem, the invention provides an apparatus according to one or more embodiment and a method and a computer program according to one or more embodiments described herein.

The invention provides an apparatus for removing an insulating layer from a length section of wire to form a coil winding of an electrical machine, the apparatus comprising:
a wire guide for guiding through the wire to be processed in a wire moving direction;
a slider arrangement having a plurality of sliders which are arranged around the wire to be guided through the wire guide and can be displaced radially back and forth relative to the wire guided in the wire guide, at least one cutting slider with a cutting edge for scraping the insulation and at least one counter bearing slider for counter-holding the wire during scraping being provided in such a way that a cutting slider and a counter bearing slider face each other and can be moved towards and away from each other, and
a cam disk with a central opening through which the wire can be guided by means of the wire guide, the cam disk being rotatable by a cam disk drive and having a first at least partially annularly revolving control cam portion for controlling and/or driving the movement of the at least one cutting slider and a second at least partially annularly revolving control cam portion for controlling and/or driving the movement of the at least one counter bearing slider.

It is preferred that the slider arrangement has at least two of the cutting sliders and at least two of the counter bearing sliders.

It is preferred that the first and second control cam portions are different portions of a common at least partially or completely annularly revolving control cam.

It is preferred that the first control cam portion and the second control cam portion are formed on axially or radially spaced different control cams.

It is preferred that the first control cam portion is formed by a first annularly revolving control cam for controlling and/or driving the movement of several, preferably all, cutting sliders and that the second control cam portion is formed by a second annularly revolving control cam for controlling and/or driving the movement of several, preferably all, counter bearing sliders. Preferably, each cutting slider engages the first control cam of the cam disk at different points spaced apart in the circumferential direction. Preferably, each counter bearing slider engages the second control cam of the cam disk at different points spaced apart in the circumferential direction.

It is preferred that the cam disk is rotationally driven by means of a servo drive as a cam disk drive controlled by an electronic control unit.

It is preferred that the cam disk is connected to the cam disk drive by means of an endless traction drive, in particular a belt drive. Preferably, a positive-locking endless traction drive is provided, for example a toothed belt drive.

It is preferred that the control cam portions and/or the control cams are formed by surfaces on the cam disk extending in a circumferential direction and in an axial direction. It is preferred that the control cam portions or control cams are formed as axially protruding beads, the sliders have pairs of cam follower elements, in particular pins or cam rollers, which receive the associated bead between them. Of course, other configurations and arrangements of control cams are also possible; for example, the or one of the control cams or control cam portions can also be formed as recesses, grooves, slots or outer edge surfaces on the cam disk. The cam disk can also be annular in shape, with an inwardly directed surface extending in a circumferential direction and an axial direction serving as the control cam.

It is preferred that the slider arrangement has sliders arranged evenly in a circle around the center in which the wire is guided.

It is preferred that the slider arrangement has a first to fourth slider.

It is preferred that the slider arrangement has a first to eighth slider.

It is preferred that the slider arrangement has several pairs of radially opposite sliders with a cutting slider and a counter-holder slider.

It is preferred that the slider arrangement can be moved in cycles with the wire. In particular, the slider arrangement or a stripping or scraping device comprising the slider arrangement can be moved back and forth in a linear direction parallel to the wire in order to be able to move with the wire. The movement is preferably carried out by means of a corresponding movement mechanism with at least one actuator controlled by a control unit. The co-movement preferably takes place in such a way that, despite the wire continuing to move, e.g. continuously (e.g. with continuous or swelling movement), there is no relative movement between the slider arrangement and the wire. Preferably, the device configured so that not only the slider arrangement, but also the entire stripping or scraping device, including the cam disk and possibly the cam disk drive, moves with it. In particular, the control unit is designed to control the movement mechanism to move the stripping or scraping device synchronously with the wire.

It is preferred that the cutting slider or sliders each have a set of blades with several blades that are designed to scrape the insulation on opposite sides of the wire.

It is preferred that the at least one cutting slider (in particular a single cutting slider or each of several cutting sliders) has one guide element per blade, which guide element is guided in a leading manner around a blade edge of the blade and has a height offset to the blade by which the penetration depth of the blade into the wire can be determined.

It is preferred that the at least one cutting slider (in particular a single cutting slider which is provided or each of several cutting sliders) has an ejector element that is elastically pre-loaded into an ejection position to support ejection of the wire from the blade set.

It is preferred that the at least one cutting slider (in particular a single cutting slider which is provided or each of several cutting sliders) has a shim between the blades for adjusting the distance between the blades.

It is preferred that the blade set has a first and a second blade.

It is preferred that the blade set comprises blades, each of which is formed from a hard metal plate having a pointed shape.

It is preferred that the blade set has blade cutting edges on the blades, the tip of which is chamfered to form a wedge angle.

It is preferred that the counter bearing slider or sliders each have a counter bearing element for contacting the wire.

It is preferred that the counter bearing slider or sliders each have guide tongs for pre-positioning the wire.

Preferably, the device has an electronic control unit—in particular a computing unit or computer such as an ECU, microcontroller or part of an overall control system of a larger production plant designed as software or hardware-which is designed to control the device to perform the steps in cycles:
a) relatively moving the apparatus and the wire to be processed in its longitudinal direction, so that a relative movement of the wire takes place through the center of the slider arrangement, and
b) stopping the relative movement and
c) rotating the cam disk to drive the sliders to scrape the insulation; and repeating steps a) to c) to strip the wire at a different length section.

In one embodiment, the wire can be moved through the stationary device or equipment in step a), then the wire movement can be stopped in step b), in order to perform step c) during the stop. In preferred embodiments, at least the slider arrangement or even a larger unit-such as in particular the stripping or scraping devices—of the apparatus or the entire apparatus is designed to be movable and is configured to be moved synchronously with the preferably continuously moving wire for performing step b), so that the slider arrangement is stationary relative to the wire for performing step c).

It is preferred that the control unit is designed to control the apparatus to rotate the cam disk with at least one complete revolution when performing step c), in order to drive the sliders for successively scraping the insulation.

According to a further aspect, the invention provides a method of removing an insulating layer on a length section of a conductor to form a coil winding of an electrical machine, the method comprising:

Providing an apparatus according to any one of the preceding claims and performing the steps in cycles:
a) relatively moving the apparatus and the wire to be processed in the longitudinal direction thereof, so that a relative movement of the wire takes place through the center of the slider arrangement, and
b) stopping the relative movement and
c) rotating the cam disk to drive the sliders to scrape the insulation; and repeating steps a) to c) to strip the wire at a different length section.

Preferably, an apparatus with at least two cutting sliders and at least two counter bearing sliders is provided, wherein step b) comprises:
rotating the cam disk at least one complete revolution to successively drive the sliders to scrape the insulation.

In one embodiment of the apparatus and/or method, step a) may involve moving the wire through the stationary device, then stopping the wire movement in step b) to then perform step c) during the stop. In preferred embodiments, at least the slider arrangement or also a larger unit or installation of the apparatus or the entire apparatus is designed to be movable and configured to be moved synchronously with the preferably continuously moving wire for performing step b), so that the slider arrangement is stationary relative to the wire for performing step c).

According to a further aspect, the invention provides a computer program comprising commands which cause the apparatus according to any one of the preceding embodiments to perform the method steps of the method according to any one of the preceding embodiments.

Preferred embodiments of the invention relate to an apparatus and a method for stripping a hairpin wire by means of scraping transversely to the wire direction.

Preferred embodiments enable scraping even in very fast industrial mass production with very short cycle times.

Preferred embodiments enable cross scraping at a relative stop of wire and stripping unit with a cycle time of Is or less.

A stop means that the wire has no relative movement to the described unit during the process and is therefore stationary. This can be achieved by stopping the wire, but preferably by moving the stripping unit with it.

Preferred embodiments of the invention have one or more of the following advantages:
stripping an endless wire (in particular hairpin wire, but it also works for stripping the ends of wave winding wires) at only one stop;
cycle time of one second (e.g. 0.4 seconds for stripping, 0.6 seconds to move the apparatus or equipment to the next stripping point);
only one servo motor required.

### BRIEF DESCRIPTION OF THE DRAWINGS

Examples of embodiments of the invention are explained in more detail below with reference to the accompanying drawings wherein it is shown by:

FIG. 1 a schematic side view of an embodiment of an apparatus for removing an insulating layer on a length section of a conductor, which apparatus comprises a device for removing an insulating layer on a length of a conductor, a movement mechanism for moving the device and a control unit;

FIG. 2 a front view of an embodiment of the device for removing an insulating layer on a length section of a conductor in the form of a wire as seen against the wire cycle direction (direction of movement of the conductor/wire);

FIG. 3 a rear view of the device of FIG. 2 as seen in the wire cycle direction;

FIG. 4 a perspective view of the device of FIGS. 2 and 3;

FIG. 5 another perspective view of the device of FIGS. 2 and 3;

FIG. 6 a perspective view of a slider arrangement, a cam disk and a cam disk drive of the device according to FIGS. 2 to 5;

FIG. 7 a front view in the direction of the wire cycle, showing a detail of the center of the slider arrangement, all sliders of the slider arrangement being out of engagement with the wire in the home position;

FIG. 8 a perspective view of the detail of FIG. 7;

FIG. 9 another perspective view of the detail of FIG. 7;

FIG. 10 a view as in FIG. 8, wherein a pair of radially opposite sliders of the slider arrangement are in engagement with the wire in an engagement position;

FIG. 11 a front view as in FIG. 7, with the pair of sliders engaged with the wire as also shown in FIG. 10, the pair of sliders comprising a cutting slider and a counter bearing slider;

FIG. 12 a front view of the pair of sliders in the home position;

FIG. 13 a perspective view of the device, partly broken away, to illustrate the configuration of the cam disk;

FIG. 14 a perspective view of the front end of the counter bearing slider directed towards the wire;

FIG. 15 a front view of the front ends of the counter bearing slider and the cutting slider directed towards the wire in the engagement position;

FIG. 16 a perspective view of the front end of the cutting slider directed towards the wire;

FIG. 17 a top view of a blade of a blade set of the cutting slider;

FIG. 18 a front view of the blade of FIG. 17;

FIG. 19 a front view of the blade set;

FIG. 20 a top view of a guide element of the cutting slider;

FIG. 21 an enlarged front view of a detail of the front end of the cutting slider, showing a pair of guide elements with an ejector element in the ejection position between them;

FIG. 22 a partially broken away top view of the front end of the cutting slider to illustrate the configuration of the ejector element;

FIG. 23 a front view of the arrangement of the pair of guide elements with the ejector element;

FIG. 24 a sectional view of a cutting edge of the cutting slider with the arrangement of FIG. 23 and the blade set;

FIG. 25 a cross-sectional view of the length section to be stripped before stripping; and

FIG. 26 the same cross-section as in FIG. 25 after stripping.

### DETAILED DESCRIPTION OF THE PREFERRED EMBODIMENTS

FIG. 1 shows a schematic block diagram of an apparatus 10 for removing an insulating layer 12 on a length section 18 of a conductor to form a coil winding of an electrical machine. The apparatus 10 is configured to strip a length section 18 at predetermined points of a wire 14 provided with an insulating layer 12 (example shown in section in FIG. 26). A wire portion located between successive stripped length sections 18 can be formed in later process steps, as described and shown in [1] to [7], into a conductor of the coil winding of the electrical machine, for example into a hairpin of a stator to be manufactured using the hairpin method.

The apparatus 10 has a (stripping or scraping) device 16 for removing the insulating layer 12 on the length sections 18, a movement mechanism 20 for moving the device 16, and a control unit 22. The control unit 22 is designed as an electronic control unit (computer) comprising a processor 22a, a memory 22b and a computer program stored therein. The control unit 22 can for example be part of an overall control system for a bending system (e.g. hairpin bending system for producing bent hairpins) or also for an overall manufacturing system for producing a component of the electrical machine, see also [1] to [7].

The apparatus 10 has a wire guide 24 which is designed to guide the wire 14 as an endless wire through the apparatus 10 in the direction of wire movement 26. In particular, the wire guide 24 is designed to guide the wire 14 through the apparatus 10. The wire movement can be continuous, swelling or clocked. The movement mechanism 20 is designed to move the device 16 along with the moving wire 14, so that the device 16 and the wire 14 are stationary relative to each other for the stripping process, as will be explained in more detail below. For this purpose, in the purely exemplary embodiment shown, the movement mechanism 20 has a carriage 30 which can be moved on a machine frame 28 and which can be moved back and forth by means of a movement actuator 32 controlled by the control unit 22. The device 16 is mounted on the carriage 30.

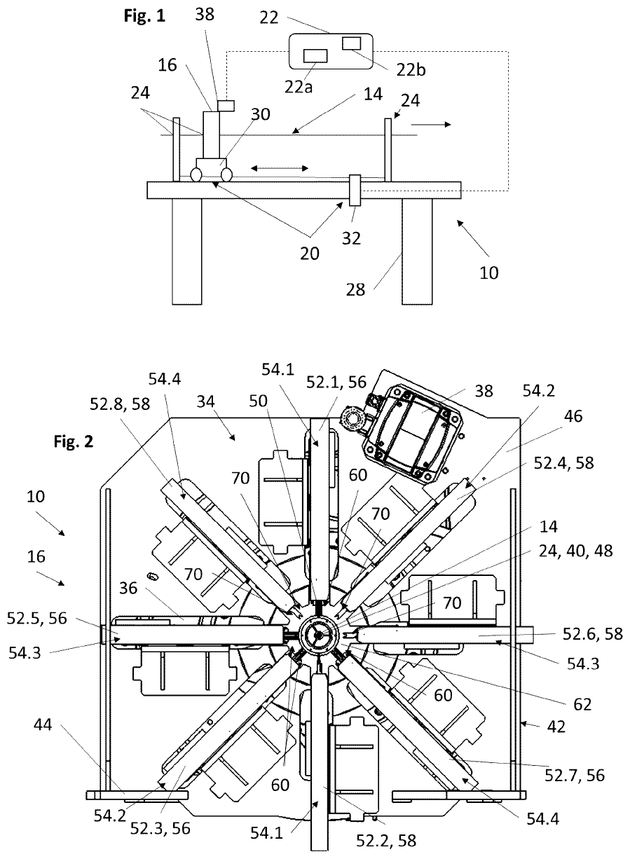

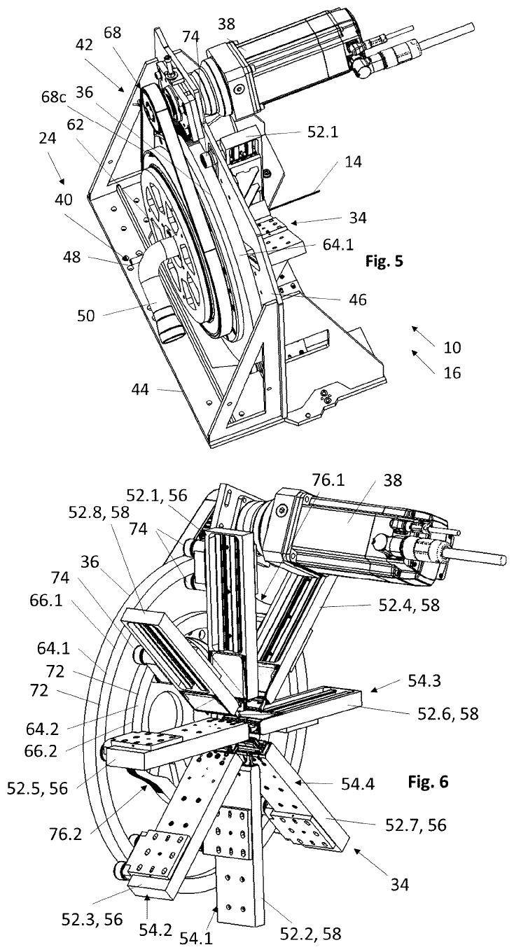

FIGS. 2 to 5 show different views of the device 16. The device 16 has a slider arrangement 34, a cam disk 36 and a cam disk drive 38. Furthermore, a wire guide unit 40 of the wire guide 24 is provided in the center of the device.

In the illustrated embodiment, the device 16 further comprises a base frame 42 (e.g. formed as a welding bracket) which can be fastened with a base 44 on the carriage 30 of the movement mechanism 20. The base frame 42 also has a mounting plate 46 which extends perpendicular to the direction of wire movement 26.

The wire guide unit 40 is guided centrally through the fastening plate 46 and has a guide tube 48 for example, through which the wire 14 is guided. For example, the guide tube 48 is arranged inside an extraction tube 50 for extracting scraped-off material of the insulating layer 12, wherein the extraction tube 50 opens towards the center of the slider arrangement 34.

The slider arrangement 34 has a plurality of sliders 52.1-52.8 which are mounted on the mounting plate 46 so as to be displaceable in a radial direction towards the wire guide unit 40 and away from it again. The sliders 52.1-52.8 are arranged opposite one another in pairs, so that at least one pair 54.1 of sliders 52.1, 52.2 and preferably at least two pairs 54.1, 54.2 of sliders 52.1-52.4 are provided. The illustrated embodiment of the device 16 has a first to fourth pair 54.1-54.4 of sliders 52.1-52.8. Each pair of sliders 54.1-54.4 has a cutting slider 56 and a counter bearing slider 58. Thus, a cutting slider 56 and a counter bearing slider 58 are radially opposite each other and can be moved between a basic position, in which the sliders 52.1-52.8 are moved radially outwards out of engagement with the wire 14, and an engagement position, in which the sliders 52.1-52.8 of the respective pair of sliders are in engagement with the wire 14. In the embodiments shown in the Figures, a first, third, fifth and seventh slider 50.1, 50.3, 50.5, 50.7 are designed as cutting sliders 52 and a second, fourth, sixth and eighth slider 50.2, 50.4, 50.6, 50.8 are designed as counter bearing sliders 54. The respective cutting slider 56 is provided with at least one cutting edge 60 for scraping the insulation. The respective counter bearing slider 58 is provided to counter-hold the wire during scraping. Thus, a cutting slider 56 and a counter bearing slider 58 face each other and can be moved towards and away from each other.

The cam disk 36 has a recess or opening, in particular a central opening 62, through which the wire 14 can be guided by means of the wire guide 24. In particular, the guide tube 48 and more particularly the concentric extraction tube 50 connected to the guide tube 48 extend through the central opening 62. The cam disk 36 is rotatably mounted on the mounting plate 46. In the embodiments shown, the cam disk 36 is rotatable about the center of the guide tube 48 and thus about the center of the wire 14 guided therein.

The rotation of the cam disk is driven by the cam disk drive 38 which is actuated by the control unit 22. The cam disk 36 has at least one mechanical control cam 64.1, 64.2 extending in a circumferential direction. On the at least one control cam 64.1, 64.2, a first at least partially annularly revolving control cam portion (extending for example in a circumferential direction at least over one ring sector) for controlling and/or driving the movement of the at least one cutting slider 56 is formed. Furthermore, on the at least one control cam 64.1, 64.2, a second at least partially annularly revolving control cam portion 66.2 (extending for example in a circumferential direction at least over one ring sector) for controlling and/or driving the movement of the at least one counter bearing slider 58 is provided.

If, as shown, several pairs of sliders 52.1-52.4 are provided, their cutting sliders 56 are arranged at different tangential positions around the wire 14 guided through the wire guide 24 and the counter bearing sliders 58 are located correspondingly opposite. In this case, all cutting sliders 56 engage the first control cam portion 66.1 at different positions spaced apart in the circumferential direction. Furthermore, all counter bearing sliders engage the second control cam portion 66.2 at different points spaced apart in the circumferential direction. Thus, when the cam disk 36 is rotated, the movements of all sliders 52.1-52.8 are driven.

In some embodiments, the cam disk drive 38 is designed as a servo drive controlled by the control unit 22. Further, in some embodiments, the cam disk 36 is connected to the cam disk drive 38 by means of an endless traction drive, in particular belt drive 68. The belt drive 68 has, for example, a toothed belt pulley 68a on the output shaft of a servomotor of the cam disk drive 38 and a toothed belt 68b, the cam disk 36 having a toothed belt pulley region 68c with a toothing at which the toothed belt 68b engages in a form-fitting manner.

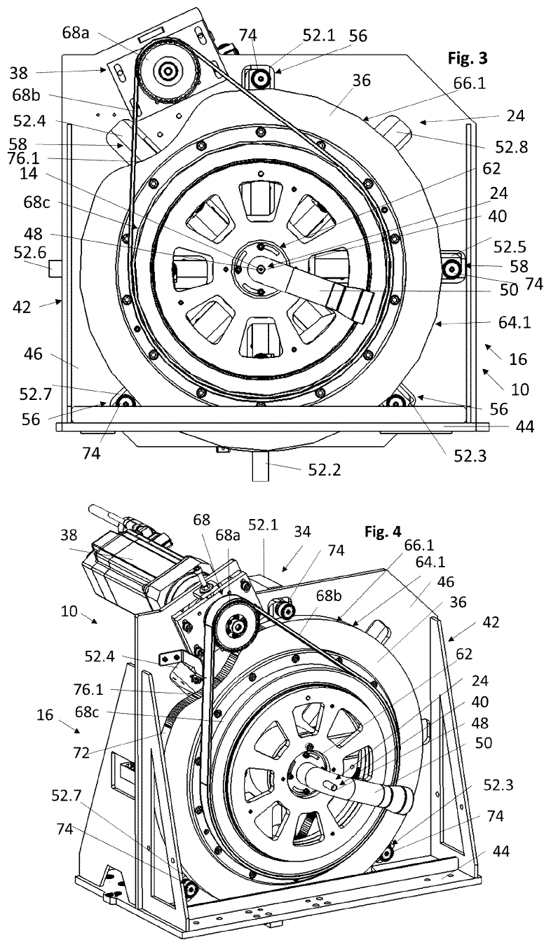

The illustrated embodiment of the apparatus 10 is designed to strip an endless hair-pin wire 14 for a specific length (e.g. 10 to 50 mm, in particular 40 mm) on all four sides and radii. The stripping process can also take place at a stop. In the embodiment shown, a stop is realized by a cycle of relative standstill—with the device 16 moving with the wire 14. FIG. 2 shows a view against the wire cycle direction—wire movement direction 26—and FIG. 3 shows a view in the wire cycle direction-wire movement direction 26.

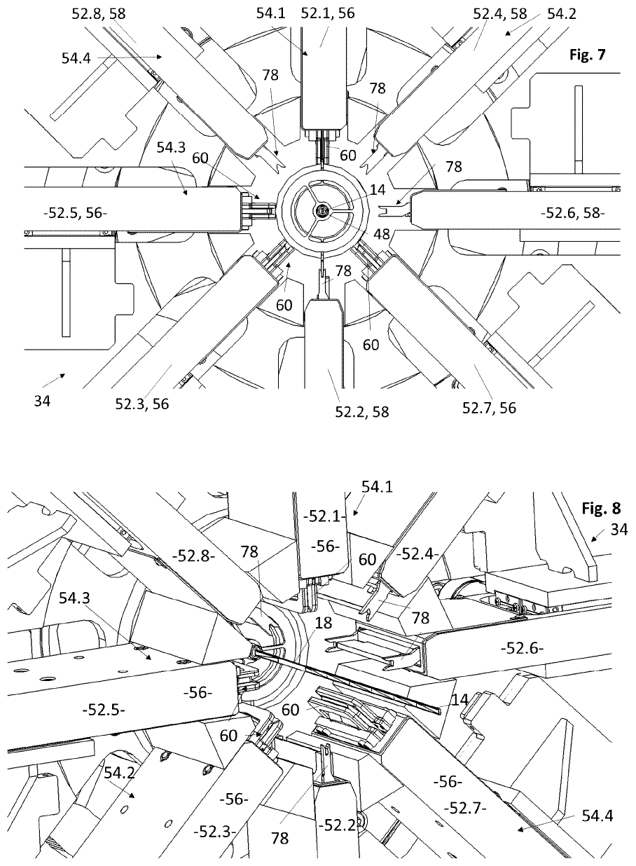

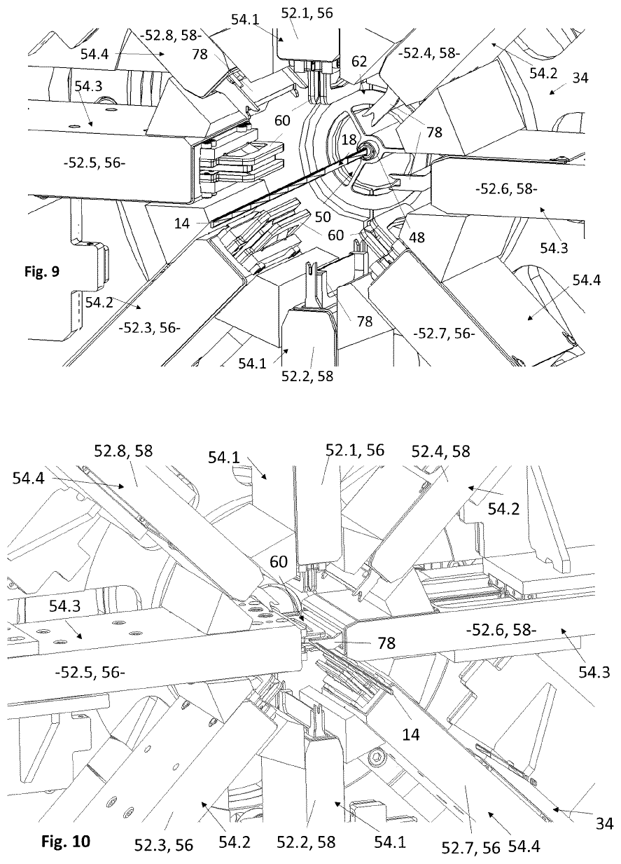

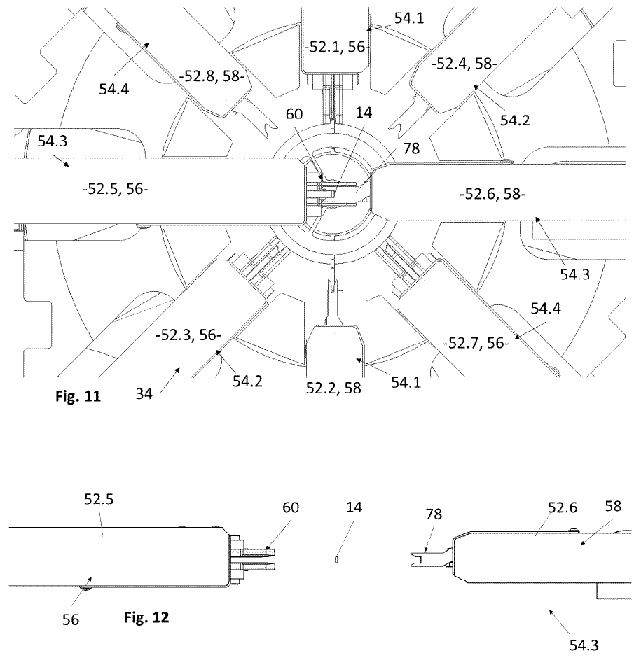

In the following, reference is made to FIGS. 6 to 13 showing different views of the slider arrangement 34 and the cam disk 36. Here, the sliders 52.1-52.8 are in the basic position in the illustrations of FIGS. 6 to 8 as well as 12 and 13, and in the illustrations of FIGS. 10 and 11 the sliders 52.5, 52.6 of one of the pairs of sliders, here for example the third pair of sliders 54.3 provided for scraping the smaller side surfaces of the rectangular wire, are in the engaged position.

The stripping device 16 of the embodiment of the apparatus 10 shown here thus essentially consists of eight sliders 52.1-52-8 which are attached to a welding bracket (example for base frame 42). In the embodiment shown, the sliders 52.1-52.8 are arranged evenly in a circle and at an angle of 45° and can be moved radially (linearly) inwards, towards the center. Two opposing sliders 52.1, 52.2; 52.2, 52.3; 52.4, 52.5; 52.5, 52.6; 52.7, 52.8 form a pair 54.1-54.4 consisting of a counter bearing slider 58 with a counter-holder 78 and a cutting slider 56 with at least one cutting edge 60.

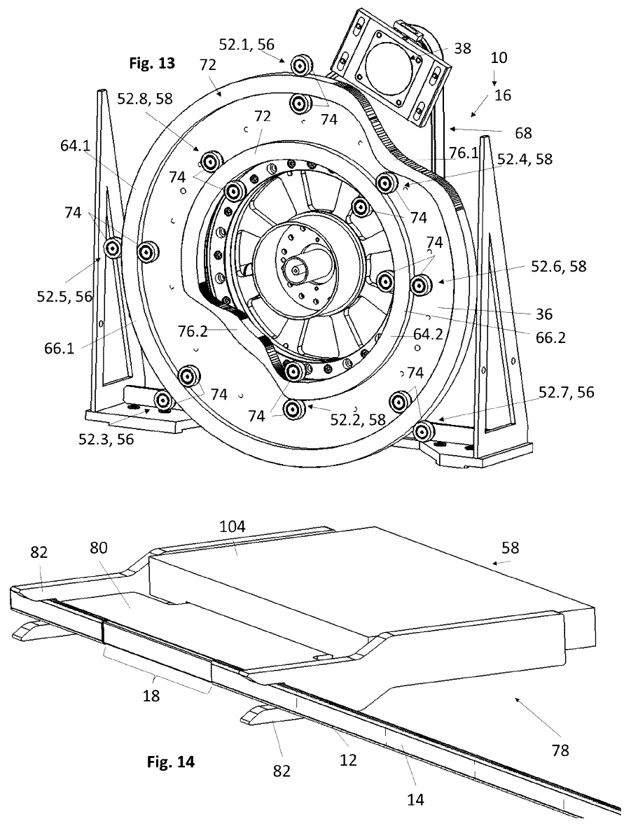

As can be seen in particular from the illustration of FIGS. 6 and 13, the first control cam portion 66.1 and the second control cam portion 66.2 are formed on different control cams 64.1, 64.2. In some embodiments (not shown), the different control cams are arranged axially spaced apart, for example on different sides of the cam disk. In the embodiments shown, the first and second control cams 66.1, 66.2 are radially spaced apart, with an inner and an outer control cam being formed.

In the embodiments shown, the first control cam portion 66.1 is designed as a surface region extending in the circumferential direction over the entire progression of the first control cam 64.1, which here annularly revolves and is designed to control and/or drive the movement of all four cutting sliders 56. The second control cam portion 66.1 is designed as a surface portion extending in the circumferential direction over the entire progression of the second control cam 64.1, which here annularly revolves and is designed to control and/or drive the movement of all counter bearing sliders 58. Preferably, the first control cam 64.1 is formed by a first bead 72.1, which preferably annularly revolves. Preferably, the second control cam 64.2 is formed by a second bead 72.2, which preferably annularly revolves.

In the embodiments shown, the control cams 64.1, 64.2 are thus formed as axially projecting beads 72.1, 72.2. The sliders 52.1-52.8 each have pairs of cam follower elements, in particular pins or cam rollers 74, which accommodate the associated bead 72.1, 72.2 between them. The majority of the revolving control cams 64.1, 64.2 runs in a circular ring-shaped manner in order to hold the sliders 52.1-52.8 acting thereon in the home position. At one region of the circumference, the first control cam 64.1 has a radially inwardly extending first indentation 76. At the point radially opposite the first indentation 76.1, the second cam 64.2 also has an inwardly extending second indentation 76.2. When the cam disk 36 is rotated, the indentations 76.1, 76.2 directed towards each other pass through the pair of cam rollers 74 of the opposing sliders 52.5, 52.6 of a pair of sliders 54.3 (in the Figures the third pair of sliders 54.3 for example), then the respective cutting slider 56 and the associated counter bearing slider 58 are thereby moved from the home position towards each other into the engaged position. Due to a different progression of the first and second bead 72.1, 72.2 with respect to the respective position in the circumferential direction, the surface progressions at the first indentation are designed differently to those of the second indentation 76.1, 76.2 in order to cause a temporally different movement of the cutting slider 56 and the associated counter bearing slider 58. The progression of the surfaces—i.e. the progression of the control curve region 66.1, 66.2 and control curves 64.1, 64.2—is such that the movement sequences of the sliders 52.1-52.8 and their elements explained below are achieved.

Accordingly, in some embodiments, cam followers 74 of all sliders 52.1-52.8 are applied against one of two beads 72 which are located on the cam disk 36. In the embodiment shown, four counter bearing sliders 58, 52.2, 52.4, 52.6, 52.8 are positioned on a second bead 72.2 forming the second control cam 64.2, while four cutting sliders 56, 52.1, 52.3, 52.5, 52.7 are positioned on the first bead 72.1 forming the first control cam 64.2. The cam disk 36 is moved by means of a belt drive 68 and a servomotor.

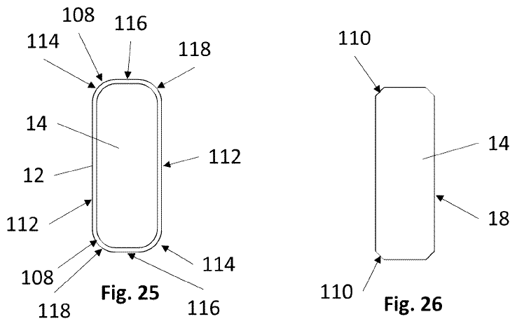

The first pair of sliders 54.1 comprising the first and second sliders 52.1, 52.2 is designed to scrape the larger side surfaces 112 of the wire 14 that is rectangular in cross-section (see FIGS. 25 and 26). The second pair of sliders 54.2 comprising the third and fourth sliders 52.3, 52.4 is designed to scrape corner edges 114 adjoining the larger side surfaces 112 in one circumferential direction. The third pair of sliders 54.4 comprising the fifth and sixth sliders 52.5, 52.6 is designed to scrape the smaller side surfaces 116 of the wire 14 that is rectangular in cross-section (see FIGS. 25 and 26). The fourth pair of sliders 54.1 comprising the seventh and eighth sliders 52.7, 52.8 is designed to scrape corner edges 118 adjoining the larger side surfaces 112 in the other circumferential direction.

During a scraping process, in the embodiment shown, the pairs of sliders 54.1-54.4 are actuated in such a way that the side surfaces 112, 116 are scraped first (in any order) and then the corner edges 114, 118 are scraped (in any order). For example, the pairs of sliders 54.1-54.4 in the illustrated embodiment are actuated in the sequence: first pair of sliders 54.1—third pair of sliders 54.3—second pair of sliders 54.2—fourth pair of sliders 54.4.

The method for removing the insulating layer on length sections 18 of the conductor formed as wire 14, which can be carried out by means of the apparatus 10, comprises the following steps:
a) relatively moving the apparatus 10 and the wire 14 to be processed in its longitudinal direction, so that a relative movement of the wire 14 through the center of the slider arrangement 34 takes place, and
b) stopping the relative movement—e.g. by moving the device 15 with the wire 14—and
c) rotating the cam disk 38 to drive the sliders 52.1-52.8 to scrape the insulation; and
repeating steps a) to c) to strip the wire 14 at another length section 18.

In this way, the continuous hairpin wire can be stripped at just one stop. For example, a cycle time of only approx. one second can be achieved, of which approx. 0.4 seconds are required for stripping and 0.6 seconds for moving the device to the next stripping point. The device 16 requires only a single servomotor (or other suitable type of cam drive 38).

In the following, an exemplary structure of the counter bearing slider 58 is explained in more detail with reference to the illustration in FIGS. 12, 14 and 15. In these Figures, the front end of the counter bearing slider 58 directed towards the wire 14 is shown with the counter-holder 78.

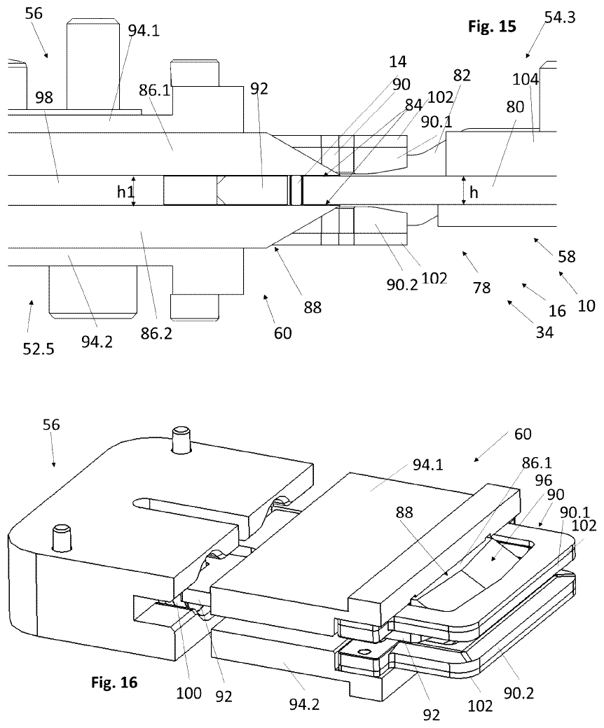

The counter-holder 78 has a counter-holder plate 80 and guide tongs 82 attached to it, which pre-position the wire 14 for the cutting edge 60. As can be seen in particular from FIG. 15, the height h of the counter-holder plate 80 is defined such that it corresponds to the desired minimum dimension of the stripped wire 14 (in the direction transverse to the direction of movement of the counter bearing slider 58 and transverse to the direction of wire movement 26) minus twice the width of a cutting gap 84 (approximately 0.05 mm to 0.1 mm). FIG. 15 also shows a first and a second blade 86.1, 86.2 of a blade set 88 of the cutting slider 56, the distance between which is set to the desired minimum dimension of the stripped wire 14.

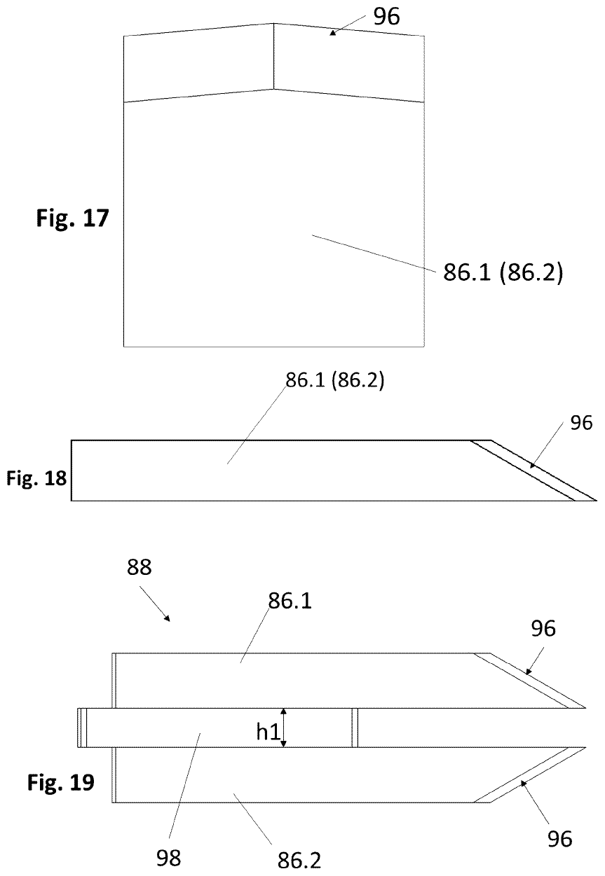

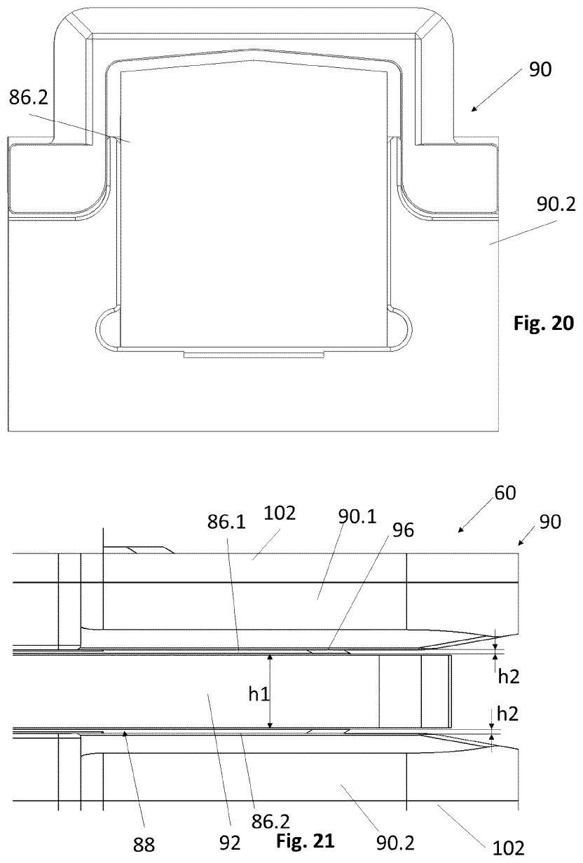

In the following, an exemplary structure of the cutting slider 56 is explained in more detail with reference to the illustration in FIGS. 12 and 15 to 24. FIG. 12 shows the front ends of the cutting slider 56 and the associated counter bearing slider 58 of one of the slider pairs 52.1-52.4, here for example the third slider pair 52.3, which are directed towards each other, whereby the sliders 56, 58 are in the basic position at a distance from the wire 14. FIG. 15 shows a detail of the front ends of the cutting slider 56 and counter bearing slider 58 in the engaged position. FIG. 16 shows a perspective view of the front end of the cutting slider 56 with the cutting edge 60. FIGS. 17 and 18 show two views of one of the blades 86.1, 86.2 of the blade set 88 of the cutting edge 60. FIG. 19 shows the blade set 88 adjusted to the appropriate distance. FIGS. 20 to 24 illustrate the arrangement of guide elements 90 and an ejector element 92 in the cutting edge 60.

As can be seen from these illustrations, the cutting edge 60 has a first blade 86.1 formed as a hard metal blade, a second blade 86.2 formed as a hard metal blade, a first and a second guide plate 90.1, 90.2 as guide elements 90 respectively assigned to the first and second blades 86.1, 86.2, a spring-loaded ejector as ejector element 92 and a first and a second retaining plate 94.1, 94.2.

As can be seen from FIGS. 17 and 18, each blade 86.1, 86.2 is a flat hard metal plate having a pointed shape. The tip is chamfered and thus forms a wedge angle 96. As shown in FIG. 19, the first and second blades 86.1, 86.2 are brought together with a shim 98 to form a blade set 88. The height h1 of the shim 98 determines the cutting dimension which leads to the above-mentioned desired wire dimension after stripping.

Reference is now made to FIGS. 20 and 21. The respective guide element 90, designed for example as a guide plate 90.1, encloses the associated blade 86.1 of the blade set 88 with a U-shape and determines the penetration depth of the blade 86.1 into the wire 14 by means of a defined height offset h2 relative to the blade 86.1.

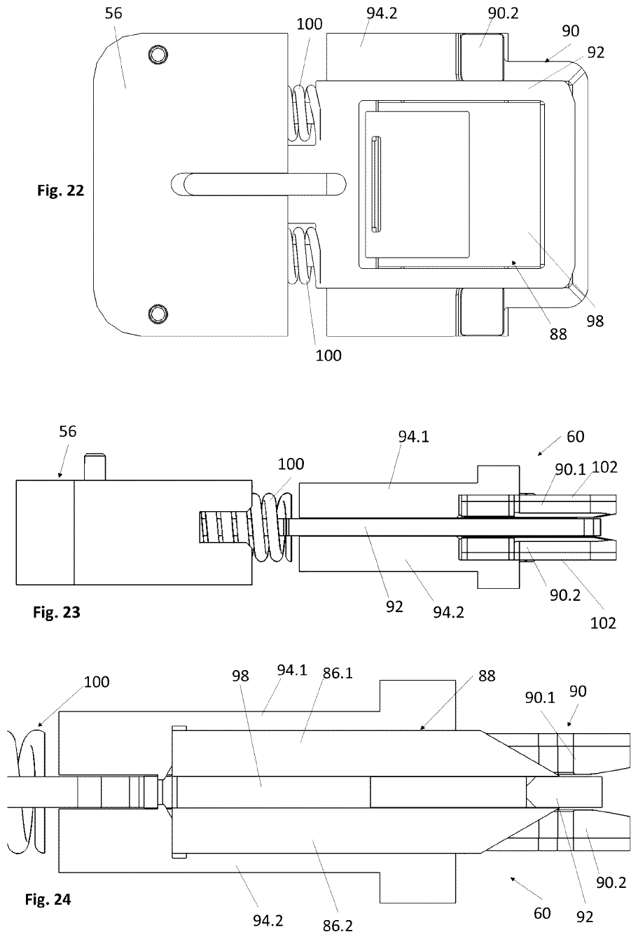

As can be seen from FIGS. 22 to 24, an ejector which is pre-loaded into its ejection position by means of spring(s) 100, is located as ejector element 92 between the tuned blades 86.1, 86.2 and the guide elements 90, for example in the form of guide plates 90.1, 90.2. The ejector element 92 is designed to push the wire 14 out of the cutting edge 60 again after stripping.

According to FIG. 24, to which reference is now made, the shim 98 between the blades 86.1, 86.2 is adjusted to the required thickness in order to set the necessary cutting dimension (dimension of the wire after stripping) on the wire. The maximum possible wire dimension before stripping is produced via guide element shims 102 on the guide elements 90. At the same time, attention should be paid to the same height difference on both sides between the guide element 90 and the blades 86.1, 86.2 in order to enable symmetrical removal.

Once the blades 86.1, 86.2 and guide elements 90 are positioned appropriately, the counter-holder 78 and the cutting edge 60 are aligned with each other by means of counter-holder shims 104 as shown in FIG. 15 in order to create an equal cutting gap 84 between the blades 86.1, 86.2 and the counter-holder 78.

In the following, a detailed example of an embodiment for a process sequence for stripping is explained as an example of an embodiment for programming the control unit 22 for controlling the functions of the apparatus and as an example of an embodiment for the method.

The wire 14 is positioned in the apparatus 10, for example as hairpin wire, by a bending system for producing hairpins in which the apparatus 10 is used. Such bending systems are known, for example, from [1] to [4]. The motion actuator drives the carriage 30 to move with the wire 14. The servomotor of the cam disk drive 38 drives the belt drive 68 and thus the cam disk with the first and second beads 72.1, 72.2. The cam rollers 74 transmit the movement to the sliders 52.1-52.8 and these move linearly towards the center.

Due to the different design of the beads 72.1, 72.2 on the cam disk 36, see FIG. 13, the counter bearing slider 58 with the counter-holder 78 is leading to the cutting slider 56 with the cutting edge 60. Shortly before the end position of the counter-holder 78 in the center, the wire 14 is held in position with little play by the several, e.g. two, guide tongs 82. In its end position, the counter-holder 78 remains in contact with the wire 14 for the time being.

The cutting slider 56 with the cutting edge 60 finally centers the wire 14 over its guide plates 90.1, 90.2, and the blades 86.1, 86.2 scrape the insulating layer 12 (including some copper). In the process, the spring-loaded ejector—ejector element 90—presses the wire 14 against the counter-holder 78—e.g. the spring 100 is compressed. Due to the arrangement of the blades 86.1, 86.2, material is scraped off the wire 14 on both sides. The finished scraped wire 14 thus moves between the blades 86.1, 86.2, see FIGS. 10, 11 and 15.

Once the cutting edge 60 has reached its end position, it is immediately moved back to the home position (radially outwards) via the contour of the first bead 72.1 and the cam rollers 74 arranged on the cutting slider 56.

The ejector element 90, designed here as a spring-loaded ejector, continues to press the wire 14 against the counter-holder 78; the spring 100 relaxes again. During the movement of the cutting edge 60, the ejector element 90 also pushes the wire 14 out of the blades 86.1, 86.2 in order to counteract deformation of the wire 14.

Once the cutter 60 has retracted far enough and the stripped wire 14 has been pressed out of the blades 86.1, 86.2, the counter-holder 78 moves to its home position. Two sides of the wire are now stripped.

The above movement sequence is repeated on the other three of the four pairs of sliders (it is repeated three more times). This means that all four sides and four radii of the wire 14 have been stripped to the previously defined width.

The following special feature arises when stripping the radii of the wire 14. Due to the linear movement of the cutting edge 60, the radius on the wire becomes a chamfer in the copper after stripping. FIG. 26 shows a cross-section through the stripping length section 18 before stripping and FIG. 27 shows the same cross-section after stripping. The radii 108 become chamfers 110 after stripping.

Further possible embodiments:

In some embodiments—not shown—the apparatus is only equipped with the first and second sliders 52.1, 52.2 and thus only has the first pair of sliders 54.1 with only two sliders, i.e. only one cutting slider 56 and one counter bearing slider 58. This is possible for hairpin methods, since in principle it is sufficient for welding the wire ends arranged in a parallel joint during welding if only the longitudinal side—larger side surface 112—of the wire 14, which abuts the other wire to be welded with it in the parallel joint during welding, is stripped (and due to the selected symmetrical design of the cutting edge also the other longitudinal side parallel to it).

In particular, in the structure with only one pair of sliders 54.1, the cam disk 36 can also be provided with only one control cam, which has the first indentation 76.1 on one circumferential region as part of the first control cam portion 66.1 for controlling the cutting slider 56 and the second indentation 76.2 on the opposite circumferential region as part of the second control cam portion 66.2 for controlling the counter bearing slider 58. The correspondingly modified only one control cam (bead) with the opposing first and second indentations 76.1, 76.2 is thus designed both for driving the movement of the cutting slider 56 and the movement of the counter bearing slider 58. The correspondingly adapted cam disk 36 is then only rotated by up to 180 degrees and then rotated back again. In one variant, the first and second beads 72.1, 72.2 can also each be formed to extend only over a partial region of the circumference; for example, they can each extend over opposite halves of a circle. In other words, in the variant with fewer sliders, for example, the part of the bead 72.1, 72.2 opposite the respective indentation 76.1, 76.2 can also be omitted.

In other embodiments, instead of beads 72.1, 72.2, other configurations are provided with the control cams on the cam disk 36, e.g. grooves, slots, edges.

In other embodiments, the slider arrangement has only the first and the second pair of sliders 54.1, 54.2 with the first to fourth sliders 52.1-52.4 for stripping the longer wire sides and adjacent radii of the wire 14. It is also possible to provide three pairs of sliders 54.1, 54.2, 54.4 so that only two opposite sides of the wire and all corner edges are stripped.

As explained above, “processing in one stop” can be processing on a moving wire with a processing device 16 moved along. By processing with one stop, the processing can be performed by a single unit—device 16 with the slider arrangement 34—instead of providing different independent units that perform the processing individually and then successively, for example.

In other embodiments, however, the device 16 can also be stationary, and the movement mechanism 20 can also be omitted. In these embodiments, the wire 14 is stopped during stripping in order to perform the rotation of the cam disk 36 for stripping when the wire 14 is stopped.

Instead of one or more of the shims 98, 102, 104, other spacers can also be provided for adjusting and setting the corresponding distance.

In order to enable process-reliable stripping of wires for the production of coil windings with fast cycle times and high quality in large-scale industrial series production, an apparatus (10) for removing an insulating layer (12) on a length section (18) of a wire (14) for forming a coil winding of an electrical machine has been described, the apparatus comprising:
a wire guide (24) for guiding through the wire (14) to be processed in a wire bending direction (26);
a slider arrangement (34) having a plurality of sliders (52.1-52.8) which are arranged around the wire (14) to be guided through the wire guide (24) and can be displaced radially back and forth relative to the wire (14) guided in the wire guide (24), wherein at least one cutting slider (56) with a cutting edge (60) for scraping the insulation (12) and at least one counter bearing slide (58) for holding the wire (14) during scraping are provided in such a way that in each case a cutting slider (56) and a counter bearing slider (58) are opposite one another and can be moved towards and away from one another, and
a cam disk (36) with a recess or opening (62) through which the wire (14) can be guided by means of the wire guide (24), the cam disk (36) being rotatable by a cam disk drive (38) and having a first at least partially annularly revolving control cam portion (66.1) for controlling and/or driving the movement of the at least one cutting slider (56) and a second at least partially annularly revolving control cam portion (66.2) for controlling and/or driving the movement of the at least one counter bearing slider (58).

Further described is a method for removing an insulating layer (12) on a length section (18) of a wire (14) for forming a coil winding of an electrical machine, the method comprising:
providing an apparatus (10) of the aforementioned type, and performing the steps in cycles:
a) relatively moving the device (10) and the wire (14) to be processed in the longitudinal direction thereof, so that a relative movement of the wire (14) through the center of the slider arrangement (34) takes place, and
b) stopping the relative movement and
c) rotating the cam disk (36) to drive the sliders (52.1-52.8) to scrape the insulation (12); and
repeating steps a) to c) to strip the wire (14) at another length section (18).

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 apparatus
12 insulating layer (electrical insulation)
14 wire (conductor)
16 device
18 length section
20 movement mechanism
22 control unit
22a processor
22b memory (with computer program stored in it)
24 wire guide
26 direction of wire movement
28 machine frame
30 carriage
32 motion actuator
34 slider arrangement
36 cam disk
38 cam disk drive
40 wire guide unit
42 base frame
44 base
46 mounting plate
48 guide tube
50 extraction tube
52.1 first slider
52.2 second slider
52.3 third slider
52.4 fourth slider
52.5 fifth slider
52.6 sixth slider
52.7 seventh slider
52.8 eighth slider
54.1 first pair of sliders
54.2 second pair of sliders
54.3 third pair of sliders
54.4 fourth pair of sliders
56 cutting slider
58 counter bearing slider
60 cutting edge
62 central opening
64.1 first control cam
64.2 second control cam
66.1 first control cam portion
66.2 second control cam portion
68 belt drive
68a toothed belt pulley
68b toothed belt
68c toothed belt pulley region
72 bead
74 cam roller
76.1 first indentation
76.2 second indentation
78c counter-holder
80 counter-holder plate
82 guide tong
84 cutting gap
86.1 first blade
86.2 second blade
88 blade set
90 guide element
90.1 first guide plate
90.2 second guide plate
92 ejector element
94.1 first retaining plate
94.2 second retaining plate
96 wedge angle
98 shim
100 spring
102 guide element shim
104 counter-holder shim
108 radius on edges of the wire
110 chamfers on corner edges of the stripped length section
112 larger side surface
114 corner edges adjoining the larger side surfaces in one circumferential direction (e.g. clockwise)
116 smaller side surface
118 corner edges adjoining the larger side surfaces in the other circumferential direction (e.g. counter-clockwise)
h height of counter bearing plate
h1 height of shim (=desired wire dimension on the stripped length section)
h2 height offset (determines the penetration depth of the blade into the wire)

Claimed is:

1. An apparatus for removing an insulating layer on a length section of wire for forming a coil winding of an electrical machine, the apparatus comprising:
a wire guide for guiding through a wire to be processed in a wire moving direction;
a slider arrangement having a plurality of sliders which are arranged around the wire to be guided through the wire guide and configured to be displaced radially back and forth relative to the wire guided in the wire guide, wherein at least one cutting slider with a cutting edge for scraping an insulation and at least one counter bearing slider for holding the wire during scraping are provided in such a way that in each case a cutting slider and a counter bearing slider are opposite one another and are configured to be moved towards and away from one another, and
a cam disk with a recess or opening through which the wire is guided by the wire guide, the cam disk being rotatable by a cam disk drive and having a first control cam portion at least partially annularly revolving control cam portion for controlling, or driving, or both a movement of the at least one cutting slider, the first control cam portion at least partially annularly revolving, and the cam disk drive also having a second control cam portion for controlling, or driving, or both, a movement of the at least one counter bearing slider, the second control cam portion at least partially annularly revolving.

2. The apparatus according to claim 1, wherein the slider arrangement comprises at least two cutting sliders and at least two counter bearing sliders.

3. The apparatus according to claim 1, wherein the first and second control cam portions are different portions of a common at least partially or completely annularly revolving control cam; or
wherein the first control cam portion and the second control cam portion are formed on axially or radially spaced different control cams; or
wherein the first control cam portion is formed by a first annularly revolving control cam for controlling, or driving, or both the movement of several or all cutting sliders and the second control cam portion is formed by a second annularly revolving control cam for controlling, or driving, or both the movement of several or all counter bearing sliders.

4. The apparatus according to claim 1, wherein the cam disk is rotationally driven by a servo drive as a cam disk drive controlled by an electronic control unit; or
wherein the cam disk is connected to the cam disk drive by an endless traction drive.

5. The apparatus according to claim 1, wherein the first and second control cam portions or control cams comprise axially projecting beads, the sliders of the plurality having pairs of cam follower elements which receive the associated axially projecting bead there between.

6. The apparatus according to claim 1, wherein the slider arrangement comprises sliders arranged evenly in a circle around a center in which the wire is guided, comprises first to fourth sliders, comprises first to eighth sliders, comprises several pairs of radially opposite sliders comprising a cutting slider and a counter-holder slider, is configured for cyclical co-movement with the wire, or a combination thereof.

7. The apparatus according to claim 1, wherein the cutting slider or sliders each have a blade set with a plurality of blades which are designed to scrape the insulation on opposite sides of the wire.

8. The apparatus according to claim 7, wherein the at least one cutting slider comprises one guide element per blade which is guided in each case in a leading manner around a blade edge of the blade and has a height offset relative to the blade by which a penetration depth of the blade into the wire is configured to be determined; or
wherein the at least one cutting slider comprises has an ejector element which is elastically pre-loaded into an ejection position to support ejection of the wire from the blade set; or
wherein the at least one cutting slider comprises a shim between the blades for adjusting a distance between the blades of the plurality; or
any combination thereof.

9. The apparatus according to claim 7, wherein the blade set comprises a first and a second blade; or
wherein the blade set comprises blades which are each formed from a hard metal plate having a pointed shape; or
wherein the blade set comprises blade cutting edges on the blades, a tip of which is chamfered to form a wedge angle; or
any combination thereof.

10. The apparatus according to claim 1, wherein each counter bearing slider comprises a counter bearing element for abutment against the wire, or guide tongs for pre-positioning the wire, or both.

11. The apparatus according to claim 1, further comprising:
an electronic control unit configured to control the apparatus to perform, in cycles, the following steps:
a) relatively moving the apparatus and the wire to be processed in a longitudinal direction thereof, so that a relative movement of the wire through a center of the slider arrangement takes place, and
b) stopping the relative movement of the wire, and
c) rotating the cam disk to drive the sliders of the plurality to scrape the insulation, and
repeating steps a) to c) to strip the wire at another length section.

12. The apparatus according to claim 11, wherein the control unit is designed to control the apparatus when performing step c) for rotating the cam disk with at least one complete revolution to successively drive the sliders to scrape the insulation.

13. A method of removing an insulating layer on a length section of wire for forming a coil winding of an electrical machine, the method comprising:
providing the apparatus according to claim 1 and performing, in cycles, the following steps:
a) relatively moving the apparatus and the wire to be processed in a longitudinal direction thereof, so that a relative movement of the wire through a center of the slider arrangement takes place, and
b) stopping the relative movement of the wire, and
c) rotating the cam disk to drive the sliders of the plurality to scrape the insulation, and
repeating steps a) to c) to strip the wire at another length section.

14. The method according to claim 13, wherein the apparatus comprises at least two cutting sliders and at least two counter bearing sliders and, wherein step b) comprises:
rotating the cam disk at least one complete revolution to successively drive the sliders of the plurality to scrape the insulation.

15. A non-transitory computer readable medium comprising a computer program comprising instructions causing a device according to perform the steps a) to c) according to claim 13.
